(19) United States
(12) Patent Application Publication
(10) Pub. No.: US 2024/0364787 A1
(43) Pub. Date: Oct. 31, 2024

(54) SESSION MANAGEMENT FUNCTION OPERATIONS

(71) Applicant: Cisco Technology, Inc., San Jose, CA (US)

(72) Inventor: Arvind Chandrakar, Bengaluru (IN)

(21) Appl. No.: 18/306,414

(22) Filed: Apr. 25, 2023

(51) Int. Cl. H04L 67/14; H04L 67/568; H04W 36/00

(52) U.S. Cl. CPC H04L 67/14; H04L 67/568; H04W 36/0022

(57) ABSTRACT

A method to operate a core network element, such as a Session Management Function (SMF) of a 5G core architecture. The method includes establishing a session between a user equipment and a core network element, determining, on the core network element, an activity pattern for the session, and based on the activity pattern, one of maintaining context information for the session in cache memory of the core network element and off-loading the context information for the session from the cache memory of the core network element to a database that is different from the cache memory.

### TECHNICAL FIELD

The present disclosure relates to fifth generation (5G) core network operations, and particularly to operations of a Session Management Function (SMF) of a 5G core network.

### BACKGROUND

A 5G core network is comprised of a plurality of functional blocks. Among them is a Session Management Function (SMF), which is one of the Control Plane (CP) Network Functions (NFs) of the core or backend network. The SMF is responsible for session management of supported individual functions on a per-session basis. More specifically, an SMF is, among other things, configured to handle session management including, e.g., session establishment, modification and release, including a tunnel between a User Plane (UP) function (UPF) and the access network (AN), user element or equipment (UE) IP address allocation and management (which may include an optional authorization), select and control the UPF for Ethernet Protocol Data Unit (PDU) sessions, configure Traffic Steering at the UPF to route traffic to the corresponding Data Network (DN), terminate interfaces toward a Policy Control Function (PCF), and control and synchronize charging data collection at the UPF. Still other functionalities may be supported by an SMF.

In some deployments, over one hundred million subscribers may be supported by a single SMF. Given the functional responsibilities of an SMF and the number of potential subscribers that a given SMF may support, efficient operation of SMF resources is desirable.

### BRIEF DESCRIPTION OF THE DRAWINGS

FIG. 1 shows an implementation of a (5G) core architecture that comprises multiple network functions (NFs), including a Session Management Function (SMF) that hosts SMF cache efficiency logic, according to an example embodiment.

FIG. 2 shows an SMF configured with SMF cache efficiency logic, along with a session context database, according to an example embodiment.

FIG. 3 shows a sequence diagram that illustrates the operations and effects of SMF cache efficiency logic, according to an example embodiment.

FIG. 4 shows a series of operations for operating an SMF that executes SMF cache efficiency logic, according to an example embodiment.

FIG. 5 is a block diagram of a computing device that may be configured to execute SMF functionality including SMF cache efficiency logic and perform the techniques described herein, according to an example embodiment.

### DETAILED DESCRIPTION

### Overview

A method to operate a core network element, such as a Session Management Function (SMF) of a 5G core architecture. The method may include establishing a session between a user equipment and a core network element, determining, on the core network element, an activity pattern for the session, and based on the activity pattern, one of maintaining context information for the session in cache memory of the core network element and off-loading the context information for the session from the cache memory of the core network element to a database that is different from the cache memory.

In another embodiment, a device is provided. The device includes an interface configured to enable network communications, a memory, and one or more processors coupled to the interface and the memory, and configured to establish a session between a user equipment and a core network element, determine, on the core network element, an activity pattern for the session, and based on the activity pattern, one of maintain context information for the session in cache memory of the core network element and off-load the context information for the session from the cache memory of the core network element to a database that is different from the cache memory.

### Example Embodiments

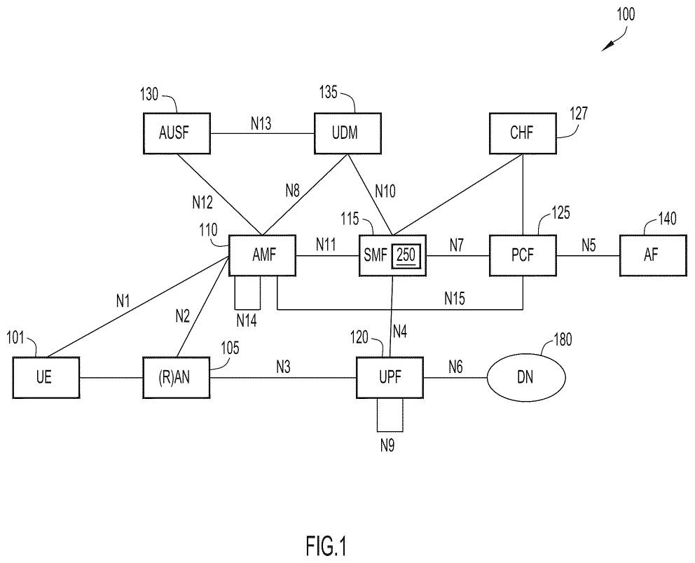

FIG. 1 shows an implementation of a (5G) core architecture 100 that comprises multiple network functions (NFs) or functional nodes, including a Session Management Function (SMF) 115 that hosts cache efficiency logic 250, according to an example embodiment.

As shown in the figure, the core architecture 100 includes an Access and Mobility Management Function (AMF) 110 that, e.g., supports termination of network address translation (NAS) signaling, NAS ciphering & integrity protection, registration management, connection management, mobility management, access authentication and authorization, and security context management.

Session Management Function (SMF) 115, as noted, supports session management (e.g., session establishment, modification, release), UE IP address allocation & management, DHCP functions, termination of NAS signaling related to session management, DL data notification, and traffic steering configuration for UPF 120 for proper traffic routing.

A User Plane Function (UPF) 120 supports, e.g., packet routing & forwarding, packet inspection, QoS handling, acts as external PDU session point of interconnect to a Data Network (DN) 180, and is an anchor point for intra-and inter-radio access technology (RAT) mobility.

A Policy Control Function (PCF) 125 supports, e.g., unified policy framework, and provides policy rules to control plane functions, and access subscription information for policy decisions in, e.g., a user data repository (UDR).

A Charging Function (CHF) 127 supports prepaid and postpaid billing. In some implementations, CHF 127 is part of PCF 125.

An Authentication Server Function (AUSF) 130 acts as an authentication server.

A Unified Data Management (UDM) 135 function supports generation of Authentication and Key Agreement (AKA) credentials, user identification handling, access authorization, and subscription management.

An Application Function (AF) 140 supports application influence on traffic routing, and interaction with policy framework for policy control.

The several NFs described above and depicted in FIG. 1 may communicate with one another via, among other connections, links N1-N15.

Still other nodes, functionality, and interconnectivity may also be provided.

Also shown in FIG. 1 is a UE 101 that may communicate over Radio Access Network, or RAN 105, and via core architecture 100 to reach DN 180.

In many implementations, and for planning purposes, the number of supported sessions on a given deployment of a combination of SMF 115/UPF 120/PCF 125/CHF 127, and other NFs, is often fixed. Such a fixed number approach works well for supporting, e.g., Enhanced Mobile Broadband (eMBB) subscribers. On the other hand, for other subscribers, including, e.g., Internet of Things (IoT) devices, massive machine type communication (mMTC), or ultra reliable low latency communication (URLLC) subscribers, where subscriber mobility and bandwidth/data utilization may be far less, the number of supported sessions may exceed a supposed maximum number of supportable sessions.

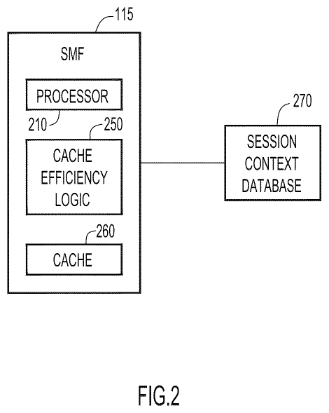

In an effort to better support different subscriber types on potentially constrained hardware and software that implements core architecture 100, FIG. 2 shows SMF 115 configured with cache efficiency logic 250, according to an example embodiment, which may be executed by processor 210. More specifically, SMF 115 operates with cache memory, or simply cache 260, to maintain the context (and context information) of each session that is being supported by core architecture 100. The capacity of cache 260 may be limited and, as such, in accordance with an embodiment, a separate session context database 270 is also provided. Session context database 270 is a memory storage device that, while possibly incorporated into SMF 115 itself, may be implemented as a networked-connected separate “box” that enables SMF 115, under instructions executed by cache efficiency logic 250, to offload session context information about selected sessions from cache 260 so that the capacity of cache 260 can be made more readily available. The offloaded sessions may be sessions that may not need the timely attention that faster cache 260 can provide, and may instead be sessions that can be supported with a slightly longer control plane (i.e., SMF functionality) latency.

Criteria upon which cache efficiency logic 250 may decide whether to cause the offloading of a given session from cache 260 to session context database 270 may include whether a number of handovers for a given subscriber, over a predetermined period of time, is relatively low or high. A high number of handovers (e.g., 3G to 4G, 4G to 5G, or 5G to wireless local area network (Wi-Fi), etc.) suggest not to offload the session for that subscriber, whereas a low number of such handovers may suggest that the session could be offloaded to session context database 270. That is, handovers generally trigger multiple NF interactions, and thus keeping a session that includes many handovers in cache 260 would be more efficient, especially if latency is a concern.

Other criteria may focus on bandwidth quota, and data usage relative to, or in view of, that quota. For example, some subscribers' quota or allotment of bandwidth for a given charging policy may be relatively low. Control plane functionality for such sessions for such subscribers may demand many exchanges between SMF 115 and CHF 127. Accordingly, session context information for such sessions would more likely be maintained in cache 260. On the other hand, where a subscriber's quota or allotment of bandwidth for a given charge may be relatively high, then there may be less control plane exchanges between SMF 115 and CHF 127, suggesting that perhaps such a session context could be offloaded to session context database 270.

Still other criteria upon which cache efficiency logic 250 may decide whether to cause the offloading of a given session from cache 260 to session context database 270 may be based on times that a given subscriber may communicate, i.e., the timing of bursts of data. For example, an IoT device may only report once per day and for a very short time, and latency may not be an issue. A session for such a subscriber could be offloaded to session context database 270, without much of an impact on the ultimate exchange of data.

A subscriber's slice distribution could also be used as a criterion for cache efficiency logic 250 determining whether to cause offloading of session context information to session context database 270. Specifically, in some use cases, different slices are used for different kinds of services, e.g., “slice 1” could be configured for Enhanced Mobile Broadband (eMBB) subscribers, “slice 2” could be configured for IoT device subscribers, and “slice 3” could be configured for URLLC subscribers. In such cases, and based on slice type, it is possible to optimize session context information cache time. For example, for an eMBB slice, cache time can be higher, and for IT or URLLC slices the session context information cache time can be shorter.

Generally speaking, access to cache 260 may be on the order of milliseconds, whereas access to session context database 270 may be on the order of 1-3 seconds. Thus, again, where latency is not an issue, storing session context information for a given session on session context database 270 may be perfectly adequate.

In one possible implementation, artificial intelligence (AI) and/or machine leaning (ML) can be applied to the operation of SMF 115, and particularly cache 260, to learn, discover, and/or ascertain patterns among subscribers and their respective sessions to help determine which subscriber sessions are candidates, or are most suited, to be offloaded to session context database 270.

Session context information that may be offloaded to session context database 270 may include data received from UDM 135, PCF 125, CHF 127, UPF 120, and/or AMF 110 as follows:

| | | | 3gpp Technical |
|---|---|---|---|
| | | | Specification |
| From | Data | Type | description |
| UDM 135 | UE session | SessionManagementSub- | 29.503 version |
| | Data | scriptionData | 16.6.0: 6.1.6.2.8 |
| PCF 125 | UE policy | SmPolicyDecision | 29.512 version |
| | data | | 16.6.0: 5.6.2.4 |
| CHF 127 | UE Charging | ChargingDataResponse | 32.291 version |
| | Data | | 16.6.0: 6.1.6.2.1.2 |
| AMF 110 | UE Session | SmContextCreateData | 29.512 version |
| | Create Data | | 16.6.0: 6.1.6.2.2 |
| UPF 120 | UE tunnel | PFCP Session | 29.244 version |
| | info | Establishment Response | 16.6.0: 7.5.3 |

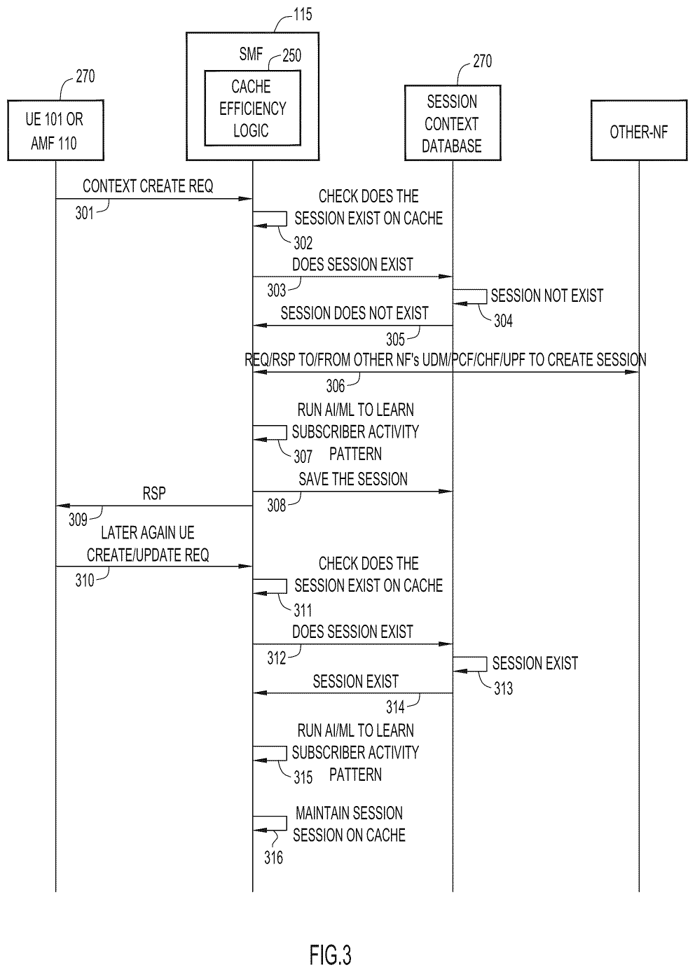

FIG. 3 shows a sequence diagram that illustrates the operations and effects of cache efficiency logic 250, according to an example embodiment.

At 301, UE 101 or AMF 110 sends a Context Create Request towards SMF 115 to create a session.

At 302, SMF 115, and more particularly, cache efficiency logic 250, checks whether the session already exists on cache 260. Since, in this case, the session is new or “fresh,” no entry is found in cache 260.

At 303, cache efficiency logic 250 checks for the session in session context database 270

At 304, it is determined that the session also does not exist on session context database 270, since it is fresh.

At 305, session context database 270 notifies cache efficiency logic 250 that the session is not found.

At 306, since there is no prior record of the session, SMF 115 interacts with other NFs in accordance with, e.g., the relevant 3GPP standards, and creates a new session in cache 260.

At 307, and in accordance with one possible embodiment, cache efficiency logic 250 may identify activity patterns for the new session by running or executing AI/ML processes on the session.

At 308, assuming the activity pattern so suggests (i.e., taking into account, e.g., handovers, burstiness, charging policies, and/or slice distribution), context information for the session is saved to session context database 270.

At 309, SMF 115 may send a response to UE 101 to establish the session with UE 101. Those skilled in the art will appreciate that operations 308 and 309 can be executed in reverse order as well.

At 310, at a later time, UE 101 undertakes a handover or some other update for the session.

At 311, cache efficiency logic 250 checks whether the session exists on session cache 260.

Then, at 312, assuming the session is not found on session cache 260, cache efficiency logic 250 queries session context database 270 for the session context information.

At 313, session context database 270 determines that the session exists in the database, and accordingly, at 314, responds that the session exists and supplies session details, i.e., session context information that was previously stored.

At 315, new activity pattern(s) may be ascertained by again running or executing AI/ML processes on the session.

At 316, and unlike after operation 307, the session is maintained in cache 260 in view of, e.g., changes in one or more of handovers, burstiness, charging policies, and/or slice distribution.

Thus, those skilled in the art will appreciate that as new sessions come online, cache efficiency logic 250 may analyze activity pattern(s) thereof and decide from time to time, or after, or in response to, a particular event, such as a session update (e.g., handover, etc.), to offload the session context information from cache 260 and save that information in session context database 270. Or, given a new activity pattern, cache efficiency logic 250 may determine to maintain the context information on cache 260. In other words, precisely where session context information is maintained is determined, dynamically, by cache efficiency logic 250 based on, e.g., the criteria described above.

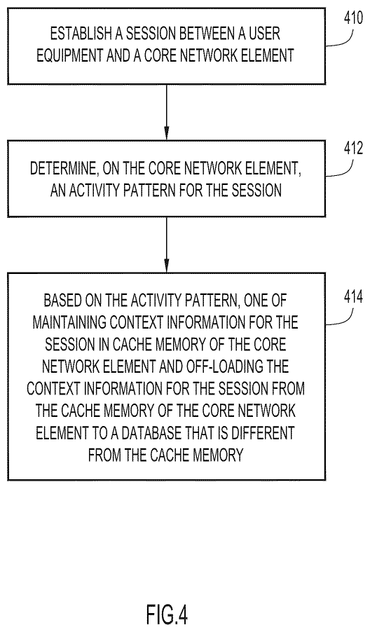

FIG. 4 shows a series of operations for operating an SMF that executes cache efficiency logic, according to an example embodiment. At 410, an operation includes establishing a session between a user equipment and a core network element. At 412, an operation includes determining, on the core network element, an activity pattern for the session. And, at 414, an operation includes, based on the activity pattern, one of maintaining context information for the session in cache memory of the core network element and off-loading the context information for the session from the cache memory of the core network element to a database that is different from the cache.

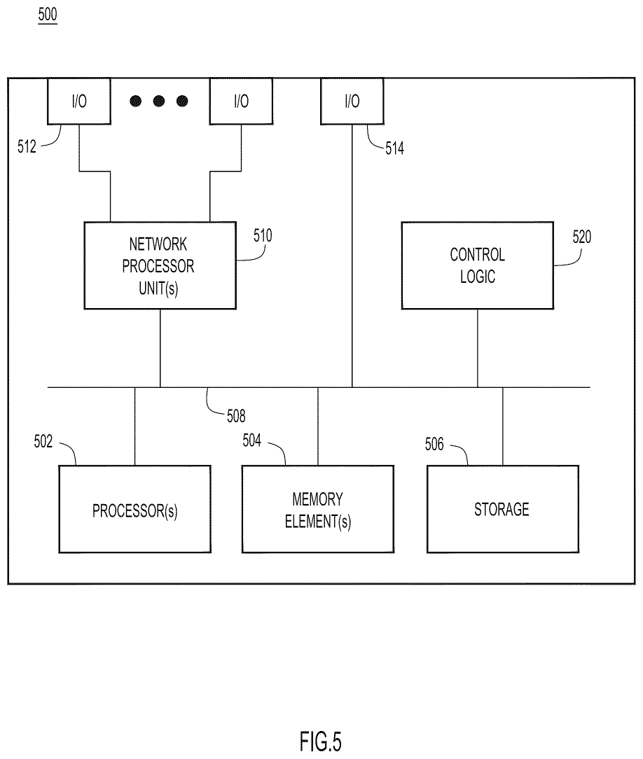

FIG. 5 is a block diagram of a computing device that may be configured to execute functionality of SMF 115 including cache efficiency logic 250 and perform the techniques described herein, according to an example embodiment. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520 (which could include, for example, cache efficiency logic 250. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment. and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally. a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one’ of and ‘one or more of’ can be represented using the ‘(s)’ nomenclature (e.g., one or more element(s)).

In sum, a method may include establishing a session between a user equipment and a core network element, determining, on the core network element, an activity pattern for the session, and based on the activity pattern, one of maintaining context information for the session in cache memory of the core network element and off-loading the context information for the session from the cache memory of the core network element to a database that is different from the cache memory.

In the method, the core network element may be a network function element of a fifth generation core network.

In the method, the core network element may be a Session Management Function (SMF) element.

The method may further include employing at least one of artificial intelligence and machine learning to determine the activity pattern for the session.

In the method, the database may be separate from the core network element and may be in communication with the core network element via a network connection.

In the method, determining the activity pattern for the session may include monitoring handovers over a predetermined period of time.

In the method, determining the activity pattern for the session may include monitoring data usage in view of a quota on data usage.

In the method, determining the activity pattern for the session may include monitoring a time period between data bursts.

In the method, determining the activity pattern for the session may include monitoring a slice distribution of a subscriber associated with the session.

In the method, the context information may include at least one of user equipment session data, user equipment policy data, user equipment charging data, user equipment session create data, user equipment tunnel information.

In another embodiment, a device may be provided and may include an interface configured to enable network communications, a memory, and one or more processors coupled to the interface and the memory, and configured to: establish a session between a user equipment and a core network element, determine, on the core network element, an activity pattern for the session, and based on the activity pattern, one of maintain context information for the session in cache memory of the core network element and off-load the context information for the session from the cache memory of the core network element to a database that is different from the cache memory.

The device may be a network function element of a fifth generation core network.

The device may be a Session Management Function (SMF) element.

In the device, the one or more processors may be configured to employ at least one of artificial intelligence and machine learning to determine the activity pattern for the session.

In the device, the database may be separate from the core network element and may be in communication with the core network element via a network connection.

In the device, the one or more processors may be further configured to determine the activity pattern for the session by monitoring handovers over a predetermined period of time.

In the device, the one or more processors may be further configured to determine the activity pattern for the session by monitoring data usage in view of a quota on data usage.

In the device, the one or more processors may be further configured to determine the activity pattern for the session by a time period between data bursts.

In yet another embodiment, one or more non-transitory computer readable storage media encoded with instructions are provided and that, when executed by a processor, cause the processor to: establish a session between a user equipment and a core network element, determine, on the core network element, an activity pattern for the session, and based on the activity pattern, one of maintain context information for the session in cache memory of the core network element and off-load the context information for the session from the cache memory of the core network element to a database that is different from the cache memory.

The core network element may include a Session Management Function (SMF) element of a fifth generation core network.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
establishing a session between a user equipment and a core network element;
determining, on the core network element, an activity pattern for the session; and
based on the activity pattern, one of maintaining context information for the session in cache memory of the core network element and off-loading the context information for the session from the cache memory of the core network element to a database that is different from the cache memory.

2. The method of claim 1, wherein the core network element is a network function element of a fifth generation core network.

3. The method of claim 1, wherein the core network element is a Session Management Function element.

4. The method of claim 1, further comprising employing at least one of artificial intelligence and machine learning to determine the activity pattern for the session.

5. The method of claim 1, wherein the database is separate from the core network element and is in communication with the core network element via a network connection.

6. The method of claim 1, wherein determining the activity pattern for the session comprises monitoring handovers over a predetermined period of time.

7. The method of claim 1, wherein determining the activity pattern for the session comprises monitoring data usage in view of a quota on data usage.

8. The method of claim 1, wherein determining the activity pattern for the session comprises monitoring a time period between data bursts.

9. The method of claim 1, wherein determining the activity pattern for the session comprises monitoring a slice distribution of a subscriber associated with the session.

10. The method of claim 1, wherein the context information comprises at least one of user equipment session data, user equipment policy data, user equipment charging data, user equipment session create data, user equipment tunnel information.

11. A device comprising:
an interface configured to enable network communications;
a memory; and
one or more processors coupled to the interface and the memory, and configured to:
establish a session between a user equipment and a core network element;
determine, on the core network element, an activity pattern for the session; and
based on the activity pattern, one of maintain context information for the session in cache memory of the core network element and off-load the context information for the session from the cache memory of the core network element to a database that is different from the cache memory.

12. The device of claim 11, wherein the core network element comprises a network function element of a fifth generation core network.

13. The device of claim 11, wherein the core network element comprises a Session Management Function element.

14. The device of claim 11, wherein the one or more processors are further configured to employ at least one of artificial intelligence and machine learning to determine the activity pattern for the session.

15. The device of claim 11, wherein the database is separate from the core network element and is in communication with the core network element via a network connection.

16. The device of claim 11, wherein the one or more processors are further configured to determine the activity pattern for the session by monitoring handovers over a predetermined period of time.

17. The device of claim 11, wherein the one or more processors are further configured to determine the activity pattern for the session by monitoring data usage in view of a quota on data usage.

18. The device of claim 11, wherein the one or more processors are further configured to determine the activity pattern for the session by a time period between data bursts.

19. One or more non-transitory computer readable storage media encoded with instructions that, when executed by a processor, cause the processor to:
establish a session between a user equipment and a core network element;
determine, on the core network element, an activity pattern for the session; and
based on the activity pattern, one of maintain context information for the session in cache memory of the core network element and off-load the context information for the session from the cache memory of the core network element to a database that is different from the cache memory.

20. The one or more non-transitory computer readable storage media of claim 19, wherein the core network element comprises a Session Management Function element of a fifth generation core network.
